(19) United States
(12) Patent Application Publication
(10) Pub. No.: US 2016/0152033 A1
(43) Pub. Date: Jun. 2, 2016

(54) Liquid Ejecting Apparatus, Ultrasonic Cleaning Device, and Ultrasonic Cleaning Method

(71) Applicant: Seiko Epson Corporation, Tokyo (JP)

(72) Inventors: Shigemi Wakabayashi, Azumino-shi (JP); Manabu Hanakawa, Matsumoto-shi (JP)

(21) Appl. No.: 14/947,806

(22) Filed: Nov. 20, 2015

(30) Foreign Application Priority Data
Dec. 1, 2014 (JP) 2014-242876

(51) Int. Cl. B41J 2/165

(52) U.S. Cl. CPC B41J 2/16552

(57) ABSTRACT

The liquid ejecting apparatus includes a recording head having a nozzle surface in which nozzles for ejecting liquid are formed, and an ultrasonic cleaning device provided with a cleaning tank that stores cleaning liquid, an ultrasonic vibrator that generates ultrasonic vibration in the cleaning liquid, and a sheet that is capable of capturing foreign substances in the cleaning liquid. The sheet is held so as to be spaced from the nozzle surface in a state in which at least the nozzle surface of the recording head is immersed in the cleaning liquid.

### CROSS REFERENCE TO RELATED APPLICATIONS

This application claims priority to Japanese Patent Application No. 2014-242876 filed on Dec. 1, 2014. The entire disclosures of Japanese Patent Application No. 2014-242876 is hereby incorporated herein by reference.

### BACKGROUND

1. Technical Field

The present invention relates to a liquid ejecting apparatus including a liquid ejecting head that ejects liquid through nozzles, an ultrasonic cleaning device that cleans the liquid ejecting head, and an ultrasonic cleaning method.

2. Related Art

A liquid ejecting apparatus is an apparatus that includes a liquid ejecting head and ejects liquid of various types from the liquid ejecting head. As the liquid ejecting apparatuses, there are image recording apparatuses such as an ink jet printer and an ink jet plotter, for example. In recent years, the liquid ejecting apparatus is also applied to manufacturing apparatuses of various types by using such technology of the liquid ejecting apparatus that can make an extremely small amount of liquid land accurately at a predetermined position. For example, the liquid ejecting apparatus is applied to a display manufacturing apparatus for manufacturing a color filter of a liquid crystal display or the like, an electrode forming apparatus for forming an electrode of an organic electroluminescence (EL) display, a field emission display (FED), or the like, and a chip manufacturing apparatus for manufacturing a biochip (biochemical element). Further, a recording head for the image recording apparatus ejects liquid ink, and a coloring material ejecting head for the display manufacturing apparatus ejects solutions of coloring materials of red (R), green (G), and blue (B). An electrode material ejecting head for the electrode forming apparatus ejects a liquid electrode material, and a bioorganic compound ejecting head for the chip manufacturing apparatus ejects a solution of a bioorganic compound.

The above-described liquid ejecting head is configured to generate pressure fluctuation in the liquid in pressure chambers by driving actuators, such as piezoelectric elements, and eject liquid droplets through nozzles opened on a nozzle surface. When the liquid droplets are ejected through the nozzles repeatedly, the liquid adheres to the nozzle surface in the vicinity of the nozzles, and the liquid is partially thickened or solidified in some cases. Further, dusts (for example, paper powder) or the like generated from a recording medium, such as recording paper, adhere to the nozzle surface and inner portions of the nozzles in some cases. When foreign substances such as the thickened liquid and the dusts adhere to the inner portions of the nozzles and the vicinities of the nozzles, there arises a risk that ejection failures such as a reduction in a liquid ejection amount and the liquid flying astray occur. In order to suppress these failures, a method of cleaning the nozzle surface with ultrasonic waves by generating the ultrasonic waves in a state in which the liquid ejecting head is immersed with cleaning liquid has been developed (for example, JP-A-2003-266719).

However, merely generating the ultrasonic waves in the state in which the liquid ejecting head is immersed with the cleaning liquid as described above raises a risk that foreign substances detached from the nozzle surface and so on suspend in the cleaning liquid and adhere to the nozzle surface and so on again. Due to this, cleaning efficiency deteriorates. As a result, it takes time to clean the liquid ejecting head to an acceptable level.

An advantage of some aspects of the invention is to provide a liquid ejecting apparatus, an ultrasonic cleaning device, and an ultrasonic cleaning method capable of cleaning a liquid ejecting head efficiently.

### SUMMARY

### APPLICATION EXAMPLE 1

A liquid ejecting apparatus according to an aspect of the invention is proposed in order to achieve the above-described advantage and includes a liquid ejecting head having a nozzle surface in which nozzles for ejecting liquid are formed; and an ultrasonic cleaning device provided with a cleaning tank that stores cleaning liquid, an ultrasonic wave transmission source that generates ultrasonic vibration in the cleaning liquid, and a capturing member that is capable of capturing foreign substances in the cleaning liquid. The capturing member is held so as to be spaced from the nozzle surface in a state in which at least the nozzle surface of the liquid ejecting head is immersed in the cleaning liquid.

According to this aspect of the invention, the capturing member is held in the cleaning liquid in the state in which the nozzle surface is immersed in the cleaning liquid. Therefore, the capturing member can capture the foreign substances in the cleaning liquid. With this, adherence of the foreign substances that have been detached from the nozzle surface through cleaning with the ultrasonic waves to the nozzle surface again can be suppressed. As a result, the cleaning efficiency can be improved, thereby shortening the cleaning time. Further, the capturing member is held so as to be spaced from the nozzle surface.

Therefore, damage to the nozzle surface by the capturing member can be suppressed.

### APPLICATION EXAMPLE 2

In the above-described configuration according to Application Example 1, the capturing member is formed to have a sheet-like shape, and the ultrasonic cleaning device includes a feeding member that holds the capturing member and feeds the capturing member into the cleaning liquid, and a collection member that collects the capturing member from the cleaning liquid.

With this configuration, a used capturing member that has captured foreign substances can be collected from the cleaning liquid and an unused capturing member that has not captured foreign substances can be fed into the cleaning liquid. Therefore, detachment of the foreign substances from the used capturing member can be suppressed. Further, the unused capturing member can capture the foreign substances more efficiently.

### APPLICATION EXAMPLE 3

In the above-described configuration according to Application Example 2, the cleaning tank includes a plurality of holding members that hold the capturing member between the feeding member and the collection member in the cleaning liquid with the capturing member opposing the nozzle surface.

With this configuration, a space between the capturing member and the nozzle surface can be adjusted by adjusting positions of the holding members. This makes it easy to position the capturing member.

### APPLICATION EXAMPLE 4

In the above-described configuration according to Application Examples 1 to 3, the ultrasonic cleaning device includes a capturing member switching mechanism capable of switching between a separation state in which a space is held between the capturing member and the nozzle surface of the liquid ejecting head that is immersed in the cleaning liquid and an abutment state in which the capturing member and the nozzle surface of the liquid ejecting head that is immersed in the cleaning liquid abut against each other, and the ultrasonic cleaning device is capable of selecting a first cleaning mode in which ultrasonic vibration is generated in the cleaning liquid by the ultrasonic wave transmission source in the separation state or a second cleaning mode in which the nozzle surface is wiped by moving the capturing member relative to the liquid ejecting head in the abutment state.

With this configuration, an appropriate cleaning mode can be selected in accordance with a contamination degree of the liquid ejecting head. For example, cleaning in the first cleaning mode is performed so as to clean the liquid ejecting head with a relatively high contamination degree. On the other hand, cleaning in the second cleaning mode is performed so as to suppress damage to the liquid ejecting head by the ultrasonic vibration. Further, the nozzle surface is wiped by the capturing member in the second cleaning mode. This eliminates the necessity of providing a wiping member or the like separately, and the configuration of the liquid ejecting apparatus can be simplified.

### APPLICATION EXAMPLE 5

In the above-described configuration according to Application Example 4, the ultrasonic cleaning device is capable of executing the first cleaning mode after the second cleaning mode in accordance with a contamination degree of the liquid ejecting head.

With this configuration, the first cleaning mode is performed after the second cleaning mode. Therefore, foreign substances that have adhered to the nozzle surface of the liquid ejecting head can be removed more reliably.

### APPLICATION EXAMPLE 6

In the above-described configuration according to Application Examples 1 to 5, the ultrasonic wave transmission source generates ultrasonic waves in a state in which a space between the nozzle surface of the liquid ejecting head that is immersed in the cleaning liquid and the capturing member is smaller than a space between the capturing member and the ultrasonic wave transmission source.

With this configuration, the foreign substances that have been detached from the nozzle surface through cleaning with the ultrasonic waves can be captured by the capturing member more reliably.

### APPLICATION EXAMPLE 7

In the above-described configuration according to Application Examples 1 to 6, the ultrasonic wave transmission source generates ultrasonic waves having a frequency of equal to or lower than 300 kHz in the cleaning liquid.

With this configuration, cleaning is performed with the ultrasonic waves having the frequency of equal to or lower than 300 kHz, thereby improving the detergency. Therefore, the cleaning efficiency with the ultrasonic waves can be further improved.

### APPLICATION EXAMPLE 8

An ultrasonic cleaning device according to another aspect of the invention for cleaning a nozzle surface of a liquid ejecting head in which nozzles for ejecting liquid are formed on the nozzle surface includes a cleaning tank that stores cleaning liquid, an ultrasonic wave transmission source that generates ultrasonic vibration in the cleaning liquid, and a capturing member that is capable of capturing foreign substances in the cleaning liquid. The capturing member is held so as to be spaced from the nozzle surface in a state in which at least the nozzle surface of the liquid ejecting head is immersed in the cleaning liquid.

With this configuration, the capturing member is held in the cleaning liquid in the state in which the nozzle surface is immersed in the cleaning liquid. Therefore, the capturing member can capture the foreign substances in the cleaning liquid. With this, adherence of the foreign substances that have been detached from the nozzle surface through cleaning with ultrasonic waves to the nozzle surface again can be suppressed. As a result, the cleaning efficiency can be improved, thereby shortening the cleaning time. Further, the capturing member is held so as to be spaced from the nozzle surface. Therefore, damage to the nozzle surface by the capturing member can be suppressed.

### APPLICATION EXAMPLE 9

An ultrasonic cleaning method according to still another aspect of the invention is an ultrasonic cleaning method of cleaning a nozzle surface of a liquid ejecting head in which nozzles for ejecting liquid are formed on the nozzle surface by an ultrasonic cleaning device provided with a cleaning tank that stores cleaning liquid, an ultrasonic wave transmission source that generates ultrasonic vibration in the cleaning liquid, and a capturing member that is capable of capturing foreign substances in the cleaning liquid, and the method includes immersing at least the nozzle surface of the liquid ejecting head in the cleaning liquid in the cleaning tank, and generating ultrasonic waves by the ultrasonic wave transmission source in a state in which the capturing member is held so as to be spaced from the nozzle surface.

With this method, the ultrasonic waves are generated by the ultrasonic wave transmission source in the state in which the capturing member is held so as to be spaced from the nozzle surface. Therefore, foreign substances can be detached from the nozzle surface with the ultrasonic waves, and the detached foreign substances are captured by the capturing member so as to suppress adherence of the foreign substances to the nozzle surface again. As a result, the cleaning efficiency can be improved, thereby shortening the cleaning time. Further, the capturing member is held so as to be spaced from the nozzle surface. Therefore, damage to the nozzle surface by the capturing member can be suppressed.

### BRIEF DESCRIPTION OF THE DRAWINGS

The invention will be described with reference to the accompanying drawings, wherein like numbers reference like elements.

FIG. 1 is a schematic view for describing the internal configuration of a printer.

FIG. 2 is a block diagram for describing the electric configuration of the printer.

FIG. 3 is a sectional view in which a main part of a recording head is enlarged.

FIG. 4A is a perspective view of an ultrasonic cleaning device, and FIG. 4B is a sectional view of the ultrasonic cleaning device.

FIG. 5 is a schematic view for describing a state of ultrasonic cleaning by the ultrasonic cleaning device.

FIG. 6 is a schematic view for describing a state of sheet wiping by the ultrasonic cleaning device.

FIG. 7 is a flowchart for describing the flow of a maintenance operation.

FIG. 8 is a table in which experimental results of the ultrasonic cleaning performed at different frequencies are summarized.

### DESCRIPTION OF EXEMPLARY EMBODIMENTS

Hereinafter, modes for carrying out the invention will be described with reference to the accompanying drawings. In the following embodiments, various limitations are made as preferable specific examples of the invention. However, the scope of the invention is not limited by these modes unless the following description particularly limits the invention otherwise. In the description below, an ink jet printer (hereinafter, simply referred to as a printer) in which an ink jet recording head (hereinafter, simply referred to as a recording head), which is one type of a liquid ejecting head, is mounted will be described as an example of a liquid ejecting apparatus according to the invention.

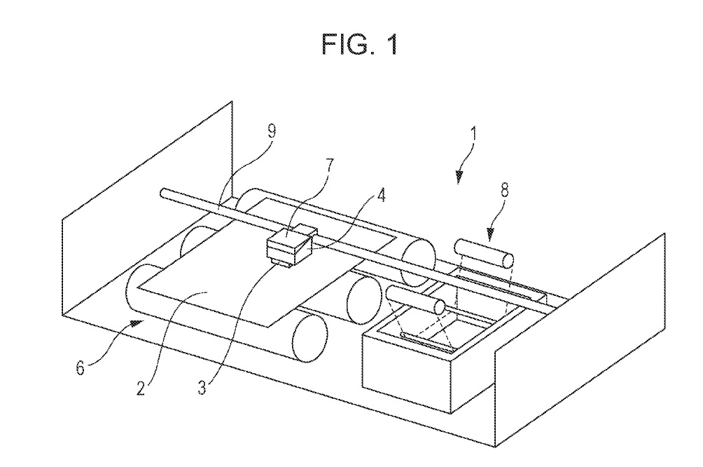

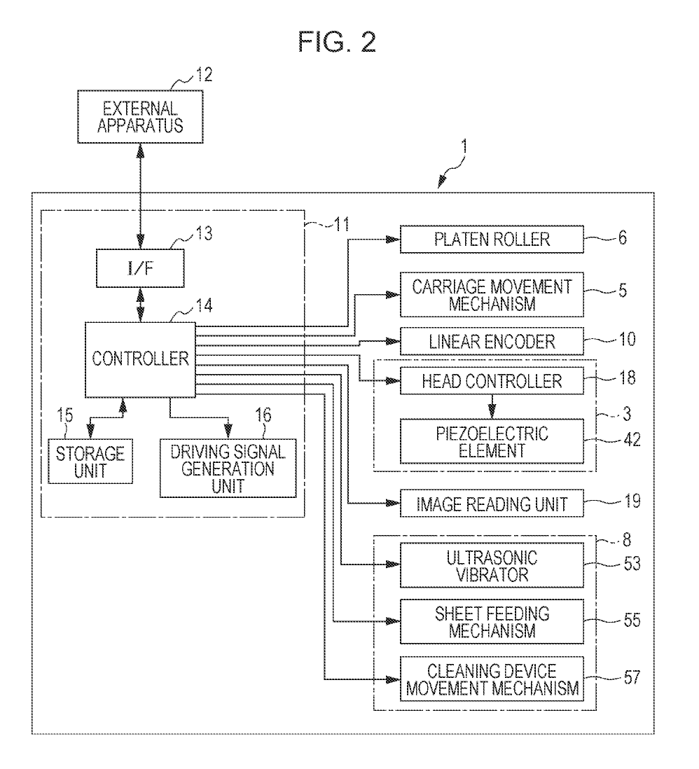

FIG. 1 is a perspective view for describing the internal configuration of a printer 1. FIG. 2 is a block diagram for describing the electric configuration of the printer 1. The printer 1 in the embodiment is electrically connected to an external apparatus 12, such as an electronic apparatus like a computer, for example, wirelessly or by a cable. The printer 1 receives print data based on an image and the like from the external apparatus 12 in order to print the image and text on a recording medium 2, such as recording paper. The printer 1 includes a printer controller 11, a recording head 3, a carriage 4 to which the recording head 3 is attached, a carriage movement mechanism 5 that moves the carriage 4 in a main-scanning direction, an ultrasonic cleaning device 8 that cleans the recording head 3, and so on. The printer 1 includes platen rollers 6, for example, serving as a mechanism for moving the recording medium 2 in a sub-scanning direction. As the movement mechanism, a drum or the like may be used instead of the platen rollers 6.

An ink cartridge 7 storing ink (one type of liquid in the invention) that is to be ejected from the recording head 3 is attached to an upper portion of the carriage 4. The ink cartridge 7 is detachably mounted on the carriage 4. The configuration in which an ink cartridge is arranged in a housing of the printer and ink is supplied to the recording head from the ink cartridge through an ink supply tube can also be employed.

The above-described carriage 4 is attached in a state of being axially supported on a guide rod 9 bridged in the main-scanning direction and is configured to move in the main-scanning direction along the guide rod 9 by an operation of the carriage movement mechanism 5 formed by a motor (not illustrated) or the like. The position of the carriage 4 in the main-scanning direction is detected by a linear encoder 10 (see FIG. 2) and a detection signal, that is, encoder pulses are transmitted to a controller 14 of the printer 1. The linear encoder 10 is one type of a positional information output unit and outputs the encoder pulses in accordance with a scan position of the recording head 3 as the positional information in the main-scanning direction.

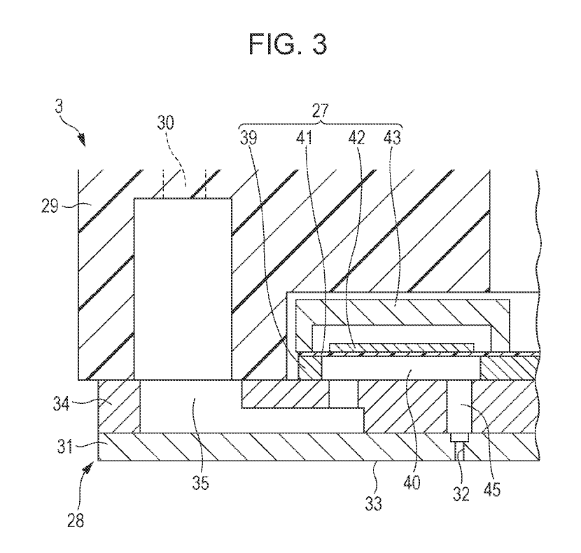

Further, an ultrasonic cleaning device 8 is arranged in a region at the outer side of a print region in a movement range of the carriage 4. The ultrasonic cleaning device 8 includes a sheet feeding mechanism 55, a cleaning device movement mechanism 57, an ultrasonic vibrator 53, and so on. The sheet feeding mechanism 55 feeds a sheet 54 into a cleaning tank 52 for cleaning the recording head 3. The cleaning device movement mechanism 57 moves the ultrasonic cleaning device 8 in the up-down direction. The ultrasonic vibrator 53 applies ultrasonic vibration to cleaning liquid 51 in the cleaning tank 52. The configuration of the ultrasonic cleaning device 8 will be described in detail later. In addition to the ultrasonic cleaning device 8, a capping member for sealing a nozzle surface 33 (see FIG. 3) of the recording head 3, a wiper member for wiping the nozzle surface 33, and so on are arranged in the region at the outer side of the print region in the movement range of the carriage 4. Neither of the capping member and the wiper member are illustrated in the drawings.

The printer 1 in the embodiment includes an image reading unit 19 that optically reads an image. The image reading unit 19 is formed by a line sensor, a digital camera, or the like, for example, and is configured to be capable of reading an image formed on the recording medium 2. Image data read by the image reading unit 19 is transmitted to the controller 14 of the printer 1. It should be noted that the image reading unit 19 may be arranged in the housing of the printer 1 or may be mounted on the carriage 4.

The printer controller 11 is a control unit that controls respective units of the printer 1. The printer controller 11 in the embodiment includes an interface (I/F) unit 13, the controller 14, a storage unit 15, and a driving signal generation unit 16. The I/F unit 13 transmits print data and a print instruction to the printer 1 from the external apparatus 12, and transmits and receives status data of the printer 1 when status information of the printer 1 is output to the external apparatus 12. The controller 14 is an arithmetic processing device that controls the printer 1 as a whole. The storage unit 15 is an element for storing programs of the controller 14 and pieces of data that are used for control of various types, and includes a read-only memory (ROM), a random-access memory (RAM), and a non-volatile RAM (NVRAM).

The controller 14 controls respective units, mechanisms, devices, and so on in accordance with the programs stored in the storage unit 15. The controller 14 in the embodiment generates ejection data indicating through which nozzles 32 and at which ink ejection timings ink is to be ejected in a print operation based on the print data from the external apparatus 12, and transmits the ejection data to a head controller 18 of the recording head 3. Further, the controller 14 analyzes the image data read by the image reading unit 19 and determines the presence or absence of print failure. The driving signal generation unit 16 generates a driving signal containing driving pulses for ejecting the ink onto the recording medium 2 and recording an image or the like.

Next, the configuration of the recording head 3 will be described. FIG. 3 is a sectional view illustrating a main part for describing the internal configuration of the recording head 3. As illustrated in FIG. 3, the recording head 3 in the embodiment includes a pressure generation unit 27 and a flow path unit 28, and these members are attached to a head case 29 in a state of being laminated.

The head case 29 is a box-shaped member made of synthetic resin, and a liquid introduction path 30 is formed in the head case 29. An upper end portion of the liquid introduction path 30 communicates with the ink cartridge 7 through a liquid flow path (not illustrated). The flow path unit 28 includes a nozzle plate 31 and a communication substrate 34. The plurality of nozzles 32 are opened in a linear form (in a row) in the nozzle plate 31. A liquid supply path 35 is provided in the communication substrate 34. The plurality of nozzles 32 arranged in a row are provided from the nozzle 32 at one end side to the nozzle 32 at the other end side at an equal interval at a pitch (for example, 180 dpi) corresponding to a dot formation density. It should be noted that the lower surface of the nozzle plate 31 corresponds to the nozzle surface 33. The liquid supply path 35 is formed so as to be elongated along the row direction of a plurality of pressure chambers 40 as a common flow path to the pressure chambers 40. The ink from the liquid introduction path 30 is distributed to the respective pressure chambers 40 through the liquid supply path 35.

The pressure generation unit 27 is unitized by stacking a pressure chamber formation substrate 39 in which the pressure chambers 40 are formed, a vibration plate 42 having flexibility, piezoelectric elements 42 serving as one type of a pressure generation unit, and a protection substrate 43 for protecting the piezoelectric elements 42. The plurality of pressure chambers 40 are linearly formed so as to correspond to the plurality of nozzles 32. The pressure chambers 40 communicate with the respective nozzles 32 through nozzle communication paths 45 formed in the communication substrate 34 at an end portion on the side opposite to communication ports of the liquid supply path 35. The piezoelectric elements 42 in the embodiment are piezoelectric elements of a so-called deflection mode and are formed so as to cover the upper portions of the pressure chambers 40. Terminal portions of the respective piezoelectric elements 42 are electrically connected to wiring members, such as flexible cables (not illustrated).

In the recording head 3 configured as described above, the ink from the ink cartridge 7 is introduced into the pressure chambers 40 through the liquid flow paths such as the liquid introduction path 30 and the liquid supply path 35. The driving signal from the controller 14 is supplied to the piezoelectric elements 42, so that the piezoelectric elements 42 are driven to generate pressure fluctuation in the pressure chambers 40. Then, ink droplets are ejected through the nozzles 32 after having passed through the nozzle communication paths 45 using the pressure fluctuation.

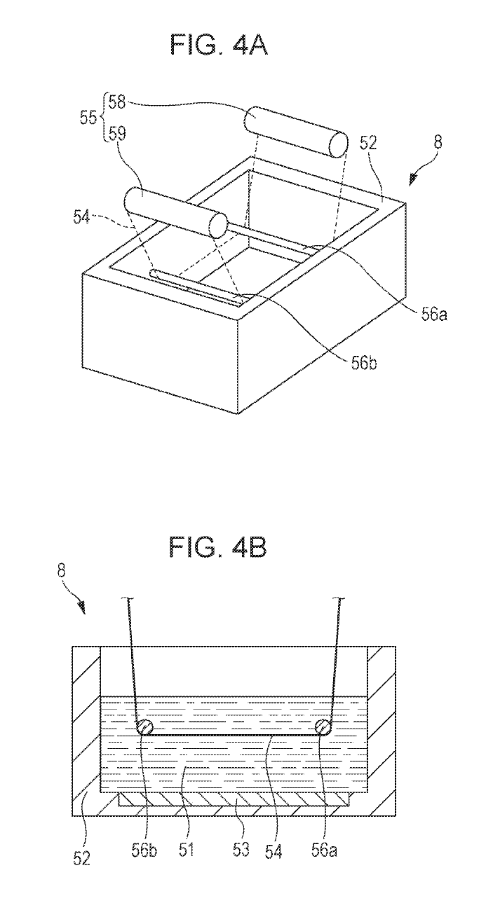

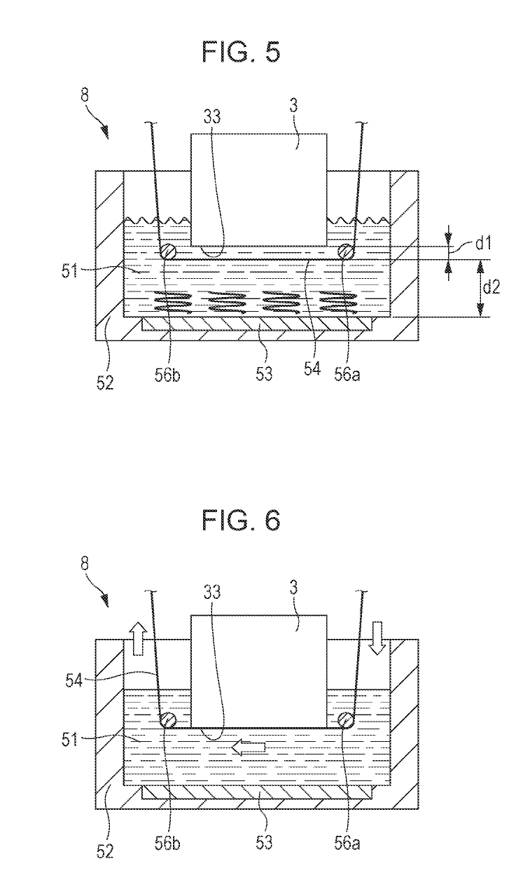

Next, the ultrasonic cleaning device 8 will be described. FIG. 4A is a perspective view of the ultrasonic cleaning device 8, and FIG. 4B is a sectional view of the ultrasonic cleaning device 8. FIG. 5 is a schematic view for describing a state of ultrasonic cleaning by the ultrasonic cleaning device 8. FIG. 6 is a schematic view for describing a state of sheet wiping by the ultrasonic cleaning device 8. In FIG. 4A, the cleaning liquid 51 is omitted and the sheet 54 is illustrated in a see-through manner.

The ultrasonic cleaning device 8 is a device that cleans the recording head 3 in order to remove foreign substances (for example, thickened or solidified ink, dusts generated from the recording medium 2, or the like) that have adhered to the nozzles 32 and the nozzle surface 33 of the recording head 3. As illustrated in FIGS. 4A and 4B, the ultrasonic cleaning device 8 in the embodiment includes the cleaning tank 52, the ultrasonic vibrator 53 (corresponding to an ultrasonic wave transmission source in the invention), the sheet 54 (corresponding to a capturing member in the invention) such as a fabric and a non-woven fabric, the sheet feeding mechanism 55, guide rollers 56 (corresponding to a holding member in the invention), and the cleaning device movement mechanism 57 (see FIG. 2). The cleaning liquid 51, such as an organic solvent and water, is stored in the cleaning tank 52. The ultrasonic vibrator 53 generates ultrasonic vibration in the cleaning liquid 51. The sheet 54 can capture foreign substances in the cleaning liquid 51. The sheet feeding mechanism 55 feeds the sheet 54 into the cleaning tank 52. The guide rollers 56 hold the sheet 54 in a state in which the sheet 54 is positioned in the cleaning liquid 51. The cleaning device movement mechanism 57 moves the ultrasonic cleaning device 8 in the up-down direction.

To describe in detail, the cleaning tank 52 is a box-shaped member the upper surface side of which is opened, and is formed to have a size capable of accommodating at least the nozzle surface 33 of the recording head 3. The guide rollers 56 are bridged in the cleaning tank 52 in the direction orthogonal to the feeding direction of the sheet 54, and the plurality of guide roller 56 are provided in the feeding direction. In the embodiment, two guide rollers 56a and 56b are arranged at an interval larger than a dimension of the nozzle surface 33 of the recording head 3 in the feeding direction of the sheet 54. These guide rollers 56a and 56b hold the sheet 54 in a posture that the sheet 54 is parallel with the nozzle surface 33 in a region between the bottom surface of the cleaning tank 52 and the nozzle surface 33 of the recording head 3. As will be described later, the distance between the nozzle surface 33 and the sheet 54 can be adjusted. Further, the ultrasonic vibrator 53 is arranged in the bottom surface of the cleaning tank 52. That is to say, in the embodiment, the bottom surface of the cleaning tank 52 corresponds to the ultrasonic wave transmission source. The cleaning tank 52 is filled with the cleaning liquid 51 to a level above the guide rollers 56.

The sheet feeding mechanism 55 is arranged above the ultrasonic vibrator 53. The sheet feeding mechanism 55 in the embodiment includes a feeding roller 58 (corresponding to a feeding member in the invention) and a collection roller 59 (corresponding to a collection member in the invention). The feeding roller 58 holds the sheet 54 in a roll form and feeds the sheet 54 into the cleaning liquid 51. The collection roller 59 collects the sheet 54 from the cleaning liquid 51 and holds the sheet 54 in a roll form. The sheet 54 is held in the cleaning liquid 51 by the two guide rollers 56a and 56b in a state of being stretched across the feeding roller 58 and the collection roller 59. That is to say, the sheet 54 fed out from the feeding roller 58 is guided to the collection roller 59 side in a state in which its distance to the nozzle surface 33 of the liquid ejecting head that is immersed in the cleaning liquid 51 is regulated by the two guide rollers 56a and 56b. Further, the ultrasonic cleaning device 8 is configured to be movable in the up-down direction by the cleaning device movement mechanism 57 formed by a driving source, such as a motor. That is to say, the ultrasonic cleaning device 8 is configured to be capable of advancing to and retreating from the recording head 3 located above it.

The ultrasonic cleaning device 8 configured as described above executes either or both of ultrasonic cleaning (corresponding to a first cleaning mode in the invention) and sheet wiping (corresponding to a second cleaning mode in the invention) in accordance with a contamination degree of the nozzle surface 33 of the recording head 3 in a maintenance operation. As illustrated in FIG. 5, the ultrasonic cleaning is a mode in which at least the nozzle surface 33 of the recording head 3 is immersed in the cleaning liquid 51 and the ultrasonic vibrator 53 is driven so as to apply ultrasonic waves to the cleaning liquid 51 from the bottom surface of the cleaning tank 52 in a separation state in which the sheet 54 is held so as to be spaced from the nozzle surface 33. The recording head 3 can be cleaned with the ultrasonic waves applied to the cleaning liquid 51. In this case, the sheet 54 is held in the cleaning liquid 51 and foreign substances in the cleaning liquid 51 can therefore be captured by the sheet 54. That is to say, the foreign substances that have been detached from the nozzle surface 33 by the ultrasonic waves and move downward by their own weight can be captured by the sheet 54, thereby suppressing adherence of the foreign substances to the nozzle surface 33 again. As a result, the cleaning efficiency can be improved, thereby shortening the cleaning time. Further, the sheet 54 is held so as to be spaced from the nozzle surface 33. Therefore, damage to the nozzle surface 33 by the sheet 54 can be suppressed.

The ultrasonic cleaning in the embodiment is performed for several minutes to several tens of minutes. For example, when water is used as the cleaning liquid 51, the ultrasonic cleaning is desirably executed for approximately 60 minutes. Although the ultrasonic cleaning provides relatively high detergency, when the frequency is low, there is a risk that ink ejection failure due to damage to an adhesive or the like between substrates constituting the recording head 3 occurs. In order to cope with this, when there is a risk that the recording head 3 is damaged, the cleaning time of the ultrasonic cleaning can be shortened. The ultrasonic cleaning desirably generates ultrasonic waves having a frequency of equal to or lower than 300 kHz in the cleaning liquid 51 and more desirably generates ultrasonic waves having a frequency of equal to or higher than 28 kHz and equal to or lower than 300 kHz. This point will be described below.

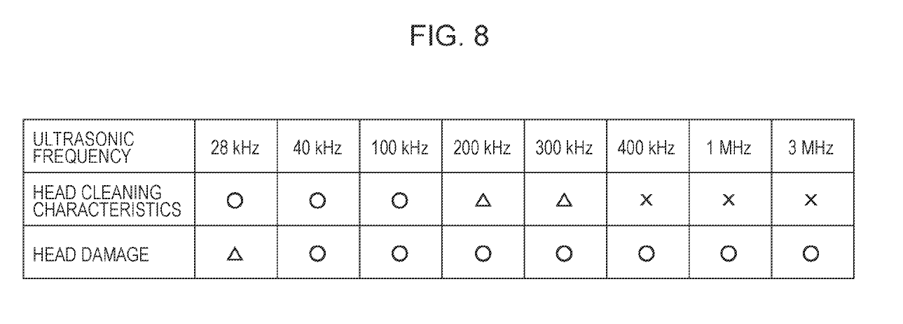

FIG. 8 is a table in which experimental results of the ultrasonic cleaning performed on the recording head 3 at different frequencies are summarized. In this experiment, the ultrasonic cleaning was performed using the recording head 3 that had not recovered even with the sheet wiping in a state in which there were a plurality of nozzles 32 that could not eject the ink (so-called, multiple nozzle omission state). Further, pure water was used as the cleaning liquid 51, and the ultrasonic cleaning was executed for 60 minutes at each of the frequencies of 28 kHz, 40 kHz, 100 kHz, 200 kHz, 300 kHz, 400 kHz, 1 MHz, and 3 MHz. As a result, when all the nozzles 32 had recovered, the “head cleaning characteristics” was marked with “◯”. When the number of nozzles 32 (nozzles 32 through which ink was not ejected) that did not recover was less than five, the “head cleaning characteristics” was marked with “Δ”. When the number of nozzles 32 that did not recover was equal to or more than five, the “head cleaning characteristics” was marked with “x”. It should be noted that the number of nozzles 32 (so-called, omitted nozzles) through which ink is not ejected is less than five, that is, the “head cleaning characteristics” is marked with “Δ”, the print quality is in an acceptable range. After the above-described ultrasonic cleaning, the recording head 3 was filled with dye-based ink and left under an environment of 70° C. for 100 hours, and print evaluation was then performed. As a result, when print failure had occurred, the “head damage” was marked with “Δ”. When the print failure did not occur, the “head damage” was marked with “◯”.

As illustrated in FIG. 8, when the frequency is equal to or higher than 400 kHz, the “head cleaning characteristics” is marked with “x”. When the frequency is 200 kHz or 300 kHz, the “head cleaning characteristics” is marked with “Δ”. Further, when the frequency is equal to or lower than 100 kHz, the “head cleaning characteristics” is marked with “◯”. Thus, the recording head 3 is desirably cleaned with the ultrasonic waves at a frequency of equal to or lower than 300 kHz from a viewpoint of detergency. When the frequency is equal to or higher than 40 kHz, the “head damage” is marked with “◯”. When the frequency is 28 kHz, the “head damage” is marked with “Δ”. Typically, as the frequency is lower, cavitation intensity generated with the ultrasonic waves increases, and damage to the recording head 3 caused by the cavitation increases. For this reason, when the frequency is lower than 28 kHz, print failure possibly occurs even if the recording head 3 is not left under the environment of 70° C. for 100 hours. In order to suppress damage to the recording head 3, the recording head 3 is desirably cleaned with the ultrasonic waves at a frequency of equal to or higher than 28 kHz. When the frequency is 28 kHz, the ultrasonic cleaning is performed for less than 60 minutes, thereby suppressing occurrence of print failure, that is, damage to the recording head 3.

On the other hand, as illustrated in FIG. 6, the sheet wiping is a mode in which the ultrasonic vibrator 53 is not driven, the nozzle surface 33 of the recording head 3 is immersed in the cleaning liquid 51, and the sheet 54 is moved relative to the recording head 3 by the sheet feeding mechanism 55 so as to wipe the nozzle surface 33 in the abutment state in which the sheet 54 abuts against the nozzle surface 33. The sheet wiping can suppress damage to the recording head 3 caused by the above-described ultrasonic vibration and shorten the cleaning time. However, the sheet wiping provides relatively low detergency and there is a risk that the recording head 3 cannot be cleaned sufficiently. Therefore, as will be described later, when the recording head 3 does not recover from ink ejection failure after execution of the sheet wiping, the ultrasonic cleaning is executed.

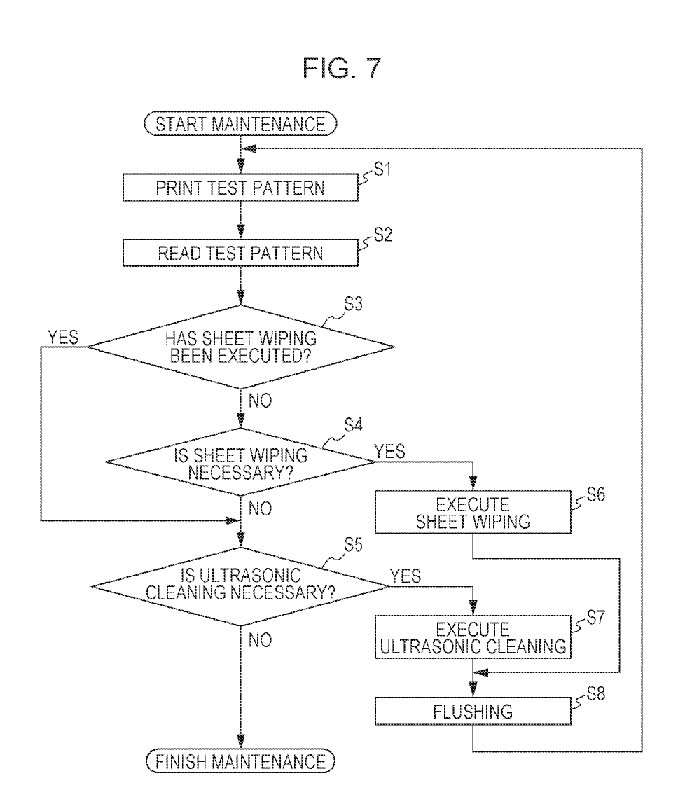

Next, the maintenance operation of the ultrasonic cleaning device 8 will be described. FIG. 7 is a flowchart for describing the flow of the maintenance operation of the printer 1. The maintenance operation is performed each time a predetermined period of time elapses during the print operation, each time a predetermined number of passes (that is to say, scanning of the recording head 3) are made, or each time a predetermined number of pages are printed.

First, a predetermined test pattern formed by a plurality of dots or the like is printed on the recording medium 2 (S1). It should be noted that the test pattern is not limited to the dots and may be ruled lines, characters, figures, symbols, or the like. Then, the printed test pattern is read by the image reading unit 19, and the read image data is transmitted to the controller 14 (S2). The controller 14 analyzes the image data and determines whether the sheet wiping has already been performed in the current maintenance operation (S3). When the dots are not read in the image analysis, for example, it is determined that there is nozzle omission. When the dots are read but a desired density value is not obtained, it is determined that the ink is flying astray (so-called alignment failure in the longitudinal direction). When the sheet wiping has not been performed (No in S3), the controller 14 determines whether the sheet wiping is necessary in accordance with the contamination degree of the recording head 3 based on an analysis result of the image data (S4). For example, when no print failure is observed, it is determined that the sheet wiping is not necessary (No in S4). Further, when the print failure is severe (for example, there are a large number of omitted nozzles and nozzles with the alignment failure in the longitudinal direction), it is also determined that the sheet wiping is not necessary (No in S4). On the other hand, when the print failure is moderate (for example, the number of omitted nozzles and nozzles with the alignment failure in the longitudinal direction is one to several), it is determined that the sheet wiping is necessary (Yes in S4).

When it is determined that the sheet wiping is necessary, the recording head 3 is moved to a position above the ultrasonic cleaning device 8 by driving the carriage movement mechanism 5. In this state, the ultrasonic cleaning device 8 is moved upward by driving the cleaning device movement mechanism 57, and the recording head 3 is immersed in the cleaning liquid 51 in the cleaning tank 52. Then, as illustrated in FIG. 6, the sheet 54 is made to abut against the nozzle surface 33, and the sheet feeding mechanism 55 is driven so as to move the sheet 54 relative to the recording head 3 and execute the sheet wiping (S6). It should be noted that the sheet wiping may be performed by an operation of moving the sheet 54 in one direction relative to the nozzle surface 33 or an operation of repeatedly moving the sheet 54 in one direction and another direction, that is, a reciprocating operation. Further, the part of the sheet 54 that has been used for wiping the nozzle surface 33 is collected to the collection roller 59 after execution of the sheet wiping. The collection to the collection roller 59 may be performed after the sheet wiping or the ultrasonic cleaning has been executed for a predetermined number of times.

When the sheet wiping has been executed, the ultrasonic cleaning device 8 is moved downward by driving the cleaning device movement mechanism 57, and the recording head 3 is moved out of the cleaning tank 52. Thereafter, a flushing operation is executed (S8). The flushing operation is an operation for forcibly discharging the cleaning liquid 51 that has entered the flow paths in the nozzles 32 of the recording head 3, the pressure chambers 40, and so on. For example, the piezoelectric elements 42 are driven and the cleaning liquid 51 is discharged into the cleaning tank 52 through the nozzles 32 in a state in which the recording head 3 is located above the ultrasonic cleaning device 8. Alternatively, a flushing box may be separately provided, and the cleaning liquid 51 may be discharged through the nozzles 32 after moving the recording head 3 to a position above the flushing box. Moreover, a cleaning operation in which the recording head 3 is moved to a position above a cap and a sealed space is depressurized by a pump (not illustrated) or the like in a state in which the nozzle surface 33 is sealed with the cap so as to suck the cleaning liquid 51 in the recording head 3 can be performed instead of the flushing operation. When the flushing operation has been executed, a test pattern is printed again (S1) in a state in which the recording head 3 is filled with ink, and the printed test pattern is read by the image reading unit 19 (S2).

Subsequently, when the sheet wiping has not been performed and it is determined that the sheet wiping is not necessary (No in S4) or when the sheet wiping has been performed once (Yes in S3), the controller 14 determines whether the ultrasonic cleaning is necessary in accordance with the contamination degree of the recording head 3 based on an analysis result of the image data (S5). For example, in the case where the sheet wiping has not been performed, when the print failure is severe, it is determined that the ultrasonic cleaning is necessary (Yes in S5). Further, in the case where the sheet wiping has been performed, when the print failure is observed, it is determined that the ultrasonic cleaning is necessary (Yes in S5) even if the print failure is moderate. This determination is made because it is considered that the recording head 3 has not recovered from the print failure by the execution of the sheet wiping in this case. On the other hand, when no print failure is observed regardless of execution of the sheet wiping, it is determined that the ultrasonic cleaning is not necessary (No in S5), and the maintenance operation is finished.

When it is determined that the ultrasonic cleaning is necessary, the recording head 3 is moved to a position above the ultrasonic cleaning device 8 by driving the carriage movement mechanism 5, as in the case of the sheet wiping. In this state, the ultrasonic cleaning device 8 is moved upward by driving the cleaning device movement mechanism 57, and the recording head 3 is immersed in the cleaning liquid 51 in the cleaning tank 52 (corresponding to a step of immersing in the invention). As illustrated in FIG. 5, the upward movement of the ultrasonic cleaning device 8 is stopped in a state in which the sheet 54 and the nozzle surface 33 are spaced from each other in order not to cause the sheet 54 to abut against the nozzle surface 33. With this, the sheet 54 stretched across the guide rollers 56a and 56b between the feeding roller 58 and the collection roller 59 is held in the cleaning liquid 51 in a state of opposing the nozzle surface 33. At this time, a state in which a space d1 between the nozzle surface 33 and the sheet 54 is narrower than a space between the sheet 54 and the bottom surface d2 of the cleaning tank 52 serving as the ultrasonic wave transmission source is desirably achieved. This can bring the sheet 54 close to the nozzle surface 33 as much as possible. In this state, ultrasonic waves are generated by driving the ultrasonic vibrator 53 without driving the sheet feeding mechanism 55 (corresponding to a step of generating ultrasonic waves in the invention). For example, the ultrasonic waves are generated for 60 minutes so as to execute the ultrasonic cleaning (S7). The part of the sheet 54 that has been immersed in the cleaning liquid 51 during the ultrasonic cleaning is collected to the collection roller 59 after execution of the ultrasonic cleaning. The collection to the collection roller 59 may be performed after the ultrasonic cleaning or the sheet wiping has been executed a predetermined number of times.

When the ultrasonic cleaning has been executed, the ultrasonic cleaning device 8 is moved downward by driving the cleaning device movement mechanism 57, and the recording head 3 is moved out of the cleaning tank 52. Thereafter, a flushing operation is executed in the same manner as that after the sheet wiping (S8). When the flushing operation has been executed, a test pattern is printed again (S1) in a state in which the recording head 3 is filled with ink, and the printed test pattern is read by the image reading unit 19 (S2). Then, the controller 14 determines whether the recording head 3 has recovered from print failure (S4 and S5). When the recording head 3 has recovered from the print failure (No in S4 and S5), the maintenance operation is finished. In the embodiment, the separation state in which the sheet 54 and the nozzle surface 33 are separated from each other and the abutment state where the sheet 54 and the nozzle surface 33 abut against each other can be switched therebetween by adjusting the position of the ultrasonic cleaning device 8 in the up-down direction. Therefore, the cleaning device movement mechanism 57 corresponds to a capturing member switching mechanism in the invention.

In this manner, the ultrasonic waves are generated by the ultrasonic vibrator 53 in a state in which the sheet 54 is held so as to be spaced from the nozzle surface 33. Therefore, foreign substances can be detached from the nozzle surface 33 by the ultrasonic waves, and the detached foreign substances are captured by the sheet 54 so as to suppress adherence of the foreign substances to the nozzle surface 33 again. As a result, the cleaning efficiency can be improved, thereby shortening the cleaning time. Further, the sheet 54 is held so as to be spaced from the nozzle surface 33. Therefore, damage to the nozzle surface 33 by the sheet 54 can be suppressed. For example, stripping or the like of a water-repellent film formed on the nozzle surface 33 can be suppressed. Further, the feeding roller 58 for feeding the sheet 54 into the cleaning liquid 51 and the collection roller 59 for collecting the sheet 54 from the cleaning liquid 51 are provided. Therefore, a used sheet 54 that has captured the foreign substances can be collected from the cleaning liquid 51, and an unused sheet 54 that has not captured the foreign substances can be fed into the cleaning liquid 51. With this, detachment of the foreign substances from the used sheet 54 can be suppressed. In addition, the foreign substances can be captured by the unused sheet 54 more efficiently. Moreover, the plurality of guide rollers 56 for holding the sheet 54 in the cleaning liquid 51 are provided. Therefore, the space between the sheet 54 and the nozzle surface 33 can be adjusted by adjusting the positions of the guide rollers 56. This makes it easy to position the sheet 54.

Further, the two cleaning modes of the ultrasonic cleaning and the sheet wiping can be executed. This enables an appropriate cleaning mode to be selected in accordance with the contamination degree of the recording head 3. That is to say, cleaning by the ultrasonic cleaning is performed so as to clean the recording head 3 with a relatively high contamination degree. On the other hand, cleaning by the sheet wiping is performed so as to suppress damage to the recording head 3 caused by the ultrasonic vibration. Further, the nozzle surface 33 is wiped by the sheet 54 during the sheet wiping. This eliminates the necessity of providing a wiping member or the like separately, and the configuration of the printer 1 can be simplified. Moreover, the ultrasonic cleaning can be executed after the sheet wiping in accordance with the contamination degree of the recording head 3. This enables foreign substances that have adhered to the nozzle surface 33 and so on of the recording head 3 to be removed more reliably.

The ultrasonic cleaning is performed in a state in which the space d1 between the nozzle surface 33 and the sheet 54 is narrower than the space between the sheet 54 and the bottom surface d2 of the cleaning tank 52 serving as the ultrasonic wave transmission source. Therefore, foreign substances that have been detached from the nozzle surface 33 through cleaning with the ultrasonic waves can be captured by the sheet 54 at a place close to the nozzle surface 33. With this, the foreign substances can be captured more reliably. In addition, the ultrasonic vibrator 53 generates the ultrasonic waves having a frequency of equal to or lower than 300 kHz in the cleaning liquid 51, thereby improving the detergency. This enables the cleaning efficiency with the ultrasonic waves to be further improved.

Meanwhile, when the recording head 3 is immersed in the cleaning liquid 51 in the sheet wiping and the ultrasonic cleaning, it is sufficient that at least the nozzle surface 33 be immersed in the cleaning liquid 51, and the remaining parts may or may not be immersed in the cleaning liquid 51. Further, the guide rollers 56 for holding the sheet 54 in the cleaning tank 52 may be configured to be movable in the up-down direction in the cleaning tank 52. For example, a roller driving mechanism that moves the guide rollers in the up-down direction is provided, and the space between the sheet and the nozzle surface is adjusted by moving the guide rollers in the up-down direction by driving the roller driving mechanism. With this configuration, the separation state in which the sheet and the nozzle surface are separated from each other and the abutment state in which the sheet and the nozzle surface abut against each other can be switched therebetween by moving the guide rollers in the up-down direction. Therefore, the positional relationship between the ultrasonic cleaning device and the recording head can be made constant in both modes of the sheet wiping and the ultrasonic cleaning. In this case, the roller driving mechanism corresponds to the capturing member switching mechanism in the invention. Further, although the guide rollers 56 are used as the holding member in the invention in the above-described embodiment, the holding member is not limited thereto. Any member that can hold the sheet 54 between the feeding roller 58 and the collection roller 59 in a state in which the sheet 54 opposes the nozzle surface 33 may be used. For example, a simple bar-like member may be used.

Although the sheet-like capturing member is used in the above-described embodiment, any member that can capture foreign substances may be employed. For example, a porous member, such as a sponge, may be used. In addition, although the cleaning device movement mechanism 57 is provided so as to move the ultrasonic cleaning device 8 in the up-down direction relative to the recording head 3 in the above-described embodiment, the invention is not limited thereto. For example, the recording head may be configured to be movable in the up-down direction and may be moved downward relative to the ultrasonic cleaning device so as to be accommodated in the cleaning tank. Further, the image reading unit 19 is provided, the printed test pattern is read by the image reading unit 19, and print failure is determined based on the image data in the above-described embodiment. However, the print failure is not limited to be determined in this manner and any method may be employed. For example, a method in which whether ink flies normally is determined by capturing an image of flying ink itself, a method in which counter electro-motive force related to the piezoelectric elements is analyzed, or the like can be used.

In addition, although the ultrasonic vibrator 53 is arranged on the bottom surface of the cleaning tank 52 in the above-described embodiment, the position of the ultrasonic vibrator 53 is not limited thereto. The ultrasonic vibrator 53 may be arranged at any desired place as long as the nozzle surface 33 of the recording head 3 can be cleaned by applying the ultrasonic waves to the cleaning liquid 51 in the cleaning tank 52. Further, although the controller 14 determines the contamination degree of the recording head 3 and the sheet wiping or the ultrasonic cleaning is executed based on a result of the determination in the above-described embodiment, the determination manner is not limited thereto. For example, the controller may determine the contamination degree of the recording head and notify a user of a result of the determination. Then, the user selects execution of the sheet wiping or the ultrasonic cleaning with reference to the notification. Alternatively, the user himself (herself) may determine the contamination degree of the recording head based on an image printed on the recording medium and may select execution of the sheet wiping or the ultrasonic cleaning.

The ink jet printer 1 has been described as an example of the liquid ejecting apparatus hereinbefore. However, the invention can be applied to other liquid ejecting apparatuses including the ultrasonic cleaning device. For example, the invention can be applied to a liquid ejecting apparatus that includes a coloring material ejecting head to be used for manufacturing a color filter of a liquid crystal display or the like, an electrode material ejecting head to be used for forming an electrode of an organic electroluminescence (EL) display, a field emission display (FED), or the like, a bioorganic compound ejecting head to be used for manufacturing a biochip (biochemical element), or the like.

What is claimed is:

1. A liquid ejecting apparatus comprising:
a liquid ejecting head having a nozzle surface in which nozzles for ejecting liquid are formed; and
an ultrasonic cleaning device provided with a cleaning tank that stores cleaning liquid, an ultrasonic wave transmission source that generates ultrasonic vibration in the cleaning liquid, and a capturing member that is capable of capturing foreign substances in the cleaning liquid,
wherein the capturing member is held so as to be spaced from the nozzle surface in a state in which at least the nozzle surface of the liquid ejecting head is immersed in the cleaning liquid.

2. The liquid ejecting apparatus according to claim 1, wherein the capturing member is formed to have a sheet-like shape; and
the ultrasonic cleaning device further includes a feeding member that holds the capturing member and feeds the capturing member into the cleaning liquid, and a collection member that collects the capturing member from the cleaning liquid.

3. The liquid ejecting apparatus according to claim 2,
wherein the cleaning tank includes a plurality of holding members that hold the capturing member between the feeding member and the collection member in the cleaning liquid with the capturing member opposing the nozzle surface.

4. The liquid ejecting apparatus according to claim 1,
wherein the ultrasonic cleaning device includes a capturing member switching mechanism capable of switching between a separation state in which a space is held between the capturing member and the nozzle surface of the liquid ejecting head that is immersed in the cleaning liquid and an abutment state in which the capturing member and the nozzle surface of the liquid ejecting head that is immersed in the cleaning liquid abut against each other, and
the ultrasonic cleaning device is capable of selecting between a first cleaning mode in which ultrasonic vibration is generated in the cleaning liquid by the ultrasonic wave transmission source in the separation state and a second cleaning mode in which the nozzle surface is wiped by moving the capturing member relative to the liquid ejecting head in the abutment state.

5. The liquid ejecting apparatus according to claim 4,
wherein the ultrasonic cleaning device is capable of executing the first cleaning mode after the second cleaning mode in accordance with a contamination degree of the liquid ejecting head.

6. The liquid ejecting apparatus according to claim 1,
wherein the ultrasonic wave transmission source generates ultrasonic waves in a state in which a space between the nozzle surface of the liquid ejecting head that is immersed in the cleaning liquid and the capturing member is narrower than a space between the capturing member and the ultrasonic wave transmission source.

7. The liquid ejecting apparatus according to claim 1,
wherein the ultrasonic wave transmission source generates ultrasonic waves having a frequency of equal to or lower than 300 kHz in the cleaning liquid.

8. An ultrasonic cleaning device for cleaning a nozzle surface of a liquid ejecting head in which nozzles for ejecting liquid are formed in the nozzle surface, the ultrasonic cleaning device comprising:
a cleaning tank that stores cleaning liquid;
an ultrasonic wave transmission source that generates ultrasonic vibration in the cleaning liquid; and
a capturing member that is capable of capturing foreign substances in the cleaning liquid,
wherein the capturing member is held so as to be spaced from the nozzle surface in a state in which at least the nozzle surface of the liquid ejecting head is immersed in the cleaning liquid.

9. An ultrasonic cleaning method of cleaning a nozzle surface of a liquid ejecting head in which nozzles for ejecting liquid are formed in the nozzle surface by an ultrasonic cleaning device provided with a cleaning tank that stores cleaning liquid, an ultrasonic wave transmission source that generates ultrasonic vibration in the cleaning liquid, and a capturing member that is capable of capturing foreign substances in the cleaning liquid, the ultrasonic cleaning method comprising:
immersing at least the nozzle surface of the liquid ejecting head in the cleaning liquid in the cleaning tank; and
generating ultrasonic waves by the ultrasonic wave transmission source in a state in which the capturing member is held so as to be spaced from the nozzle surface.

10. The ultrasonic cleaning method according to claim 9,
wherein the capturing member is formed to have a sheet-like shape, and
the ultrasonic cleaning method further includes:
feeding the capturing member into the cleaning liquid; and
collecting the capturing member from the cleaning liquid.

11. The ultrasonic cleaning method according to claim 10,
wherein the cleaning tank includes a plurality of holding members that hold the capturing member between the feeding member and the collection member in the cleaning liquid with the capturing member opposing the nozzle surface.

12. The ultrasonic cleaning method according to claim 9, further comprising:
switching between a separation state in which a space is held between the capturing member and the nozzle surface of the liquid ejecting head that is immersed in the cleaning liquid and an abutment state in which the capturing member and the nozzle surface of the liquid ejecting head that is immersed in the cleaning liquid abut against each other; and
generating ultrasonic vibration in the cleaning liquid by the ultrasonic wave transmission source in the separation state; and
wiping the nozzle surface by moving the capturing member relative to the liquid ejecting head in the abutment state.

13. The ultrasonic cleaning method according to claim 12,
wherein the generating of the ultrasonic vibration is executed after the wiping in accordance with a contamination degree of the liquid ejecting head.

14. The ultrasonic cleaning method according to claim 9,
wherein the ultrasonic wave transmission source generates ultrasonic waves in a state in which a space between the nozzle surface of the liquid ejecting head that is immersed in the cleaning liquid and the capturing member is narrower than a space between the capturing member and the ultrasonic wave transmission source.

15. The ultrasonic cleaning method according to claim 9,
wherein the ultrasonic wave transmission source generates ultrasonic waves having a frequency of equal to or lower than 300 kHz in the cleaning liquid.
